(19) United States
(12) Patent Application Publication
(10) Pub. No.: US 2015/0157431 A1
(43) Pub. Date: Jun. 11, 2015

(54) Toothbrush Dryer Towel

(71) Applicant: Wanda Ruffin-Proctor, Red Lion, PA (US)

(72) Inventor: Wanda Ruffin-Proctor, Red Lion, PA (US)

(21) Appl. No.: 14/566,293

(22) Filed: Dec. 10, 2014

Related U.S. Application Data
(60) Provisional application No. 61/913,972, filed on Dec. 10, 2013.

(51) Int. Cl. A61C 15/00

(52) U.S. Cl. CPC A61C 15/00

(57) ABSTRACT

The present invention discloses a toothbrush dryer towel. The disposable rectangular fabric includes a pair of juxtaposed plies with coextensive exterior and interior surfaces, wherein the upper ply is composed of water absorbent material and the lower ply is composed of water impermeable material. The plies are designed to be stacked on one another wherein the interior surface of the upper ply is placed in contact and above the exterior surface of the lower ply. The rectangular fabric is designed to be wrapped around the head of a toothbrush wherein the front edge of the fabric is wrapped over the rear edge. The fabric further includes a reusable tape attached to substantially the middle of the front edge to removably adhere to the exterior surface of the lower ply to removably secure the fabric therearound. A plurality of fabrics may be stacked together and stored in a box.

### CROSS REFERENCE TO RELATED APPLICATION

This application claims the benefit of U.S. Provisional Application No. 61/913,972 filed on Dec. 10, 2013. The above identified patent application is herein incorporated by reference in its entirety to provide continuity of disclosure.

### BACKGROUND OF THE INVENTION

### Field of the Invention

The present invention relates to health and personal care. More specifically, the present invention pertains to an improved toothbrush dryer towel for oral care. The present invention a disposable rectangular fabric having a pair of juxtaposed plies with coextensive exterior and interior surfaces, wherein the upper ply is composed of water absorbent material and the lower ply is composed of water impermeable material. The present invention is designed to wrap around the head of the toothbrush to dry a toothbrush faster, while also allowing air to circulate to prevent a moist environment that can bacteria growth.

One of the main purposes of a toothbrush is to remove bacteria from your mouth. Therefore, it is very important to keep your toothbrush sanitary and free of bacteria. When you travel, a toothbrush should be kept in a travel toothbrush holder to prevent it from rolling around uncovered in a toiletry bag where it can pick up dust, dirt and bacteria. The same can be said at home where many people place their toothbrushes on the bathroom counter where it can be a germ-infested surface. It is generally recommended for toothbrushes to stored upright in a cup or a toothbrush holder that allows it to air dry and has several openings to keep multiple toothbrushes separate. A personal travel toothbrush holder is not recommended at home as the chronically moist environment therein can promote bacteria growth than the open air. A toothbrush should also not be stored in a closed cabinet as the air does not circulate therein.

The present invention provides a solution that allows for a toothbrush to air dry faster and prevents a moist environment that can foster bacteria growth. The present invention includes a disposable rectangular fabric that is designed to wrap around the head of the toothbrush, in a tubular fashion, to dry a toothbrush faster, while also allowing air to circulate to prevent a moist environment that can bacteria growth.

The disposable rectangular fabric includes a coextensive upper ply composed of water absorbent material and lower ply composed of water impermeable material. The interior surface of the lower ply is designed to be wrapped around the head of a toothbrush wherein the front edge of the fabric is wrapped over and above the rear edge. The fabric further includes a reusable tape attached to substantially the middle of the front edge designed to removably adhere to the exterior surface to removably secure the fabric therearound toothbrush. A plurality of disposable rectangular fabrics can be stacked on one another in a box.

### Description of the Prior Art

Devices have been disclosed in the prior art that relate to toothbrush dryers and paper towels. These include devices that have been patented and published in patent application publications. One patent discloses a towel to facilitate the transfer of moisture from the surface wiped having a series of projections on one side and aligning indentations on the opposite side. Other patents describe a housing and a heating or drying means secured therein. These devices, however, do not disclose a rectangular fabric designed to wrap around the head of a toothbrush and removably adhered by a reusable tape to secure the fabric therearound. The foregoing is a list of devices deemed most relevant to the present disclosure, which are herein described for the purposes of highlighting and differentiating the unique aspects of the present invention, and further highlighting the drawbacks existing in the prior art.

Specifically, U.S. Pat. No. 1,167,603 to Swift provides a towel to facilitate the transfer of moisture from the surface wiped. The Swift device discloses a sheet of paper fabric with suitable texture having a series of projections substantially triangular in shape on one side of the paper. The opposite side of the paper has corresponding indentions. However, the Swift device does not provide a rectangular fabric having a reusable tape to secure the fabric therearound.

Similarly, U.S. Pat. No. 6,874,247 to Hsu discloses a toothbrush dryer having a housing and a heating device therein housing. The Hsu device discloses a housing have a sidewall, a top wall portion and a cover pivotally secured to the top wall portion and a bottom wall plate. The cover is designed to open and define an interior within the housing. The heating device includes a drying pan situated at a bottom portion of the housing designed to transfer heat from the heating device to a toothbrush therein housing. The heating device further includes a heating element electrically connected to a power source. However, the Hsu device does not disclose a rectangular fabric designed to wrap around the head of a toothbrush.

U.S. Pat. No. 4,845,859 to Evans provides a toothbrush storage and dryer system. The Evans device discloses an upright cylindrical housing having an open top and closed sidewall. The Evans device further discloses a plate that subdivides the housing into an upper chamber for receiving the toothbrush and a lower chamber. Lower chamber includes a heat source designed to provide heat to dry toothbrush therein upper chamber. However, the Evans device does not provide a rectangular fabric having an upper ply composed of water absorbent material and a coextensive lower ply composed of water impermeable material.

U.S. Pat. No. 7,225,559 to Padilla provides a toothbrush dryer having a hollow housing with a pair of side walls, rear wall, and an open front in communication with an interior chamber. A door hingedly engages one of the sidewalls and encloses the interior chamber. Mounted within the interior chamber are a plurality of toothbrush retaining clips. A heating and blower assembly is mounted within the interior chamber to dry the toothbrushes inserted therein. However, the Padilla device does not provide a rectangular fabric including a reusable tape to secure the fabric therearound.

Finally, U.S. Pat. No. 3,820,251 to Abernathy provides a toothbrush drying device. The Abernathy device discloses a housing having toothbrush accommodating means therein and a removable cover. The Abernathy device further discloses a heating means in the housing for heating the air in the housing thereby drying toothbrushes in the housing, control means coupled to the heating means, and a source of ultra violet light near toothbrush accommodating means for destroying bacteria on toothbrushes therein housing. However, the Abernathy device does not provide a rectangular fabric having an upper ply composed of water absorbent material and a coextensive lower ply composed of water impermeable material designed to wrap around the head of a toothbrush.

The devices disclosed in the prior art have several known drawbacks. These devices are limited as they do not disclose a disposable fabric designed to be removably wrapped around the head of a toothbrush. Some patents provide a towel to facilitate the transfer of moisture from the surface wiped having a series of projections on one side and aligning indentations on the opposite side. Other patents describe a housing and a heating or drying means secured therein. The present invention overcomes these limitations by disclosing a disposable rectangular fabric having an upper ply composed of water absorbent material and a coextensive lower ply with water impermeable material designed to be removably wrapped around the head of a toothbrush. The fabric further includes a reusable tape attached to the front edge designed to removably adhere to the rear edge to temporarily secure the fabric therearound toothbrush. It is therefore submitted that the present invention is substantially divergent in design elements from the prior art, and consequently it is clear that there is a need in the art for an improvement to disposable toothbrush dryers. In this regard, the instant invention substantially fulfills these needs.

### SUMMARY OF THE INVENTION

In view of the foregoing disadvantages inherent in the known types of toothbrush dryers now present in the prior art, the present invention provides a new and improved toothbrush dryer towel which is designed to wrap around the head of the toothbrush to dry a toothbrush faster, while also allowing air to circulate to prevent a moist environment that can bacteria growth.

It is therefore an object of the invention to provide a new and improved toothbrush dryer towel that has all of the advantages of the prior art and none of the disadvantages.

Another object of the present invention is to provide a new and improved toothbrush dryer towel that includes a disposable rectangular fabric having an upper ply composed of a water absorbent material and a coextensive lower ply composed of a water impermeable material.

Yet another object of the present invention is to provide a new and improved toothbrush dryer towel that further includes a reusable tape that is substantially attached in the middle of the front edge of the fabric.

Still yet another object of the present invention is to provide a new and improved toothbrush dryer towel, which is designed to wrap around the head of the toothbrush to dry a toothbrush faster.

Another object of the present invention is to provide a new and improved toothbrush dryer towel, which is designed to allow air to circulate to prevent a moist environment that can bacteria growth.

Yet another object of the present invention is to provide a new and improved toothbrush dryer towel, which further comprises a box that is designed to store a plurality of the rectangular fabrics.

An object of the present invention is to provide a new and improved toothbrush dryer towel that is disposable and easy to use.

Still yet another object of the present invention is to provide a new and improved toothbrush dryer towel wherein the device may be readily fabricated from materials that permit relative economy and are commensurate with durability.

Other objects, features, and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein the numeral annotations are provided throughout.

FIG. 1 shows a perspective of the present invention with a toothbrush laying thereon.

FIG. 2 shows a cross section of the present invention.

FIG. 3 shows a perspective of the present invention as removably wrapped around the head of the toothbrush.

FIG. 4 shows a front perspective of an alternative embodiment of the present invention.

FIG. 5 shows a perspective of the present invention as stored within a box.

### DETAILED DESCRIPTION OF THE INVENTION

References are made herein to the attached drawings. Like reference numerals are used throughout the drawings to depict like or similar elements of the toothbrush dryer towel. For the purposes of presenting a brief and clear description of the present invention, the preferred embodiment will be discussed as used to wrap around the head of a toothbrush. The figures are intended for representative purposes only and should not be considered to be limiting in any respect.

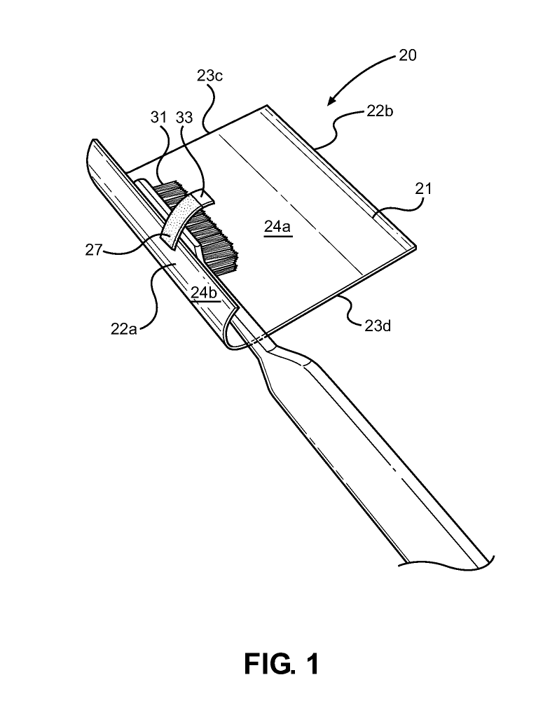

Referring now to FIG. 1 there is shown a perspective of the toothbrush dryer towel 20 with a conventional toothbrush 31 thereon. Towel 20 comprises a fabric 21 having a rectangular shape with a front edge 22A, a rear edge 22B, an upper side 23C, and a lower side 23D. The fabric 21 further includes a pair of juxtaposed plies 24A, B, wherein the upper ply 24A is placed in contact and above the coextensive lower ply 24B. The fabric 21 further comprises a reusable tape 27 attached to substantially the middle of the front edge 22A and is designed to removably adhere to the rear edge 22B to removably secure the fabric 21 around a toothbrush 31 in a tubular and cylindrical fashion. The towel 20 is designed to allow for a toothbrush to air dry faster and prevent a moist environment that can foster bacteria growth.

The upper ply 24A is composed of a water absorbent material, preferably composed of virgin paper pulp. Without limitation, other embodiments are composed of recycled pulp or a combination of virgin and recycled paper pulp. The upper ply 21A is designed to soak and absorb water, wherein the upper ply 21A is loosely woven to enable water to travel between the weaves even against gravity. The upper ply 24A may further include resin to improve the wet strength, such as, polyamide-epichlorohydrin resins or polyacrylamide resins. Furthermore, the lower ply 24B is composed of a water impermeable material, which enables water to be confined within the fabric 21 and prevents absorbed water from travelling and transferring onto other surfaces the fabric 21 may contact.

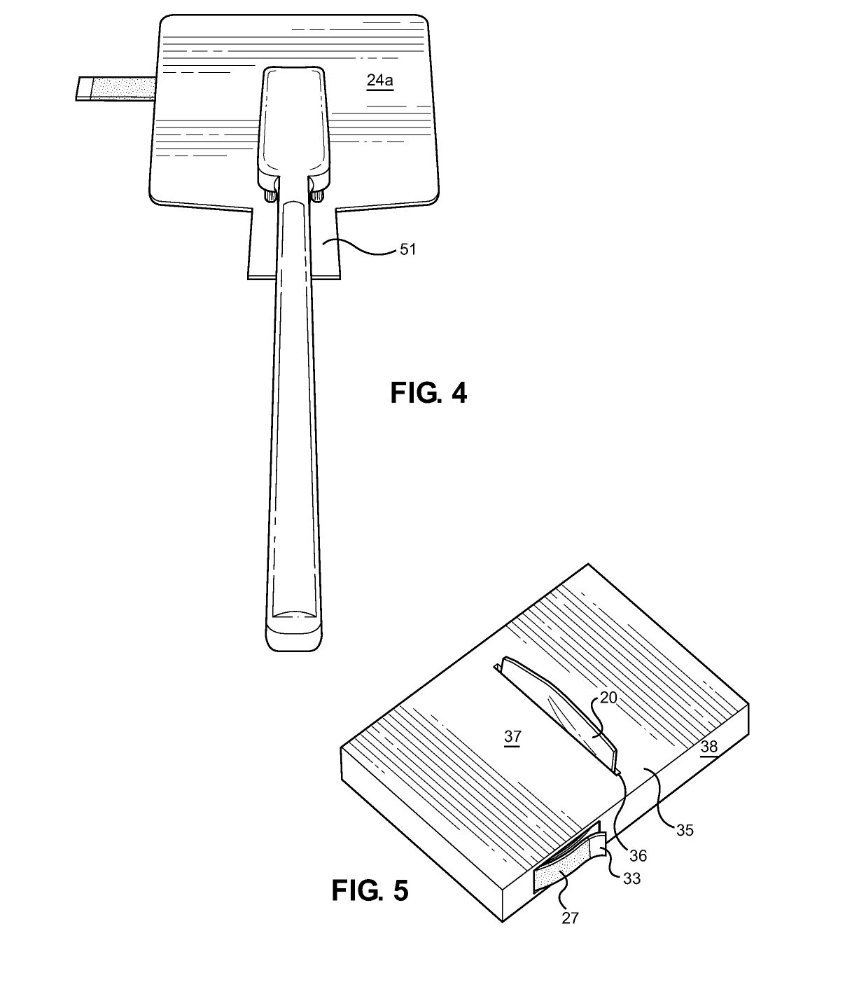

In some embodiments, such as the one illustrated in FIG. 4, the fabric 21 may further comprise a rectangular portion 51 attached substantially to the middle of the lower side 23D. The rectangular portion 51 further comprises the same upper ply 24A and the lower ply. The rectangular portion 51 is particularly advantageous, as the rectangular portion 51 increases the surface area to absorb water on the bristles mounted on the toothbrush head and prevents water from the head of the toothbrush from contacting the handle of the toothbrush.

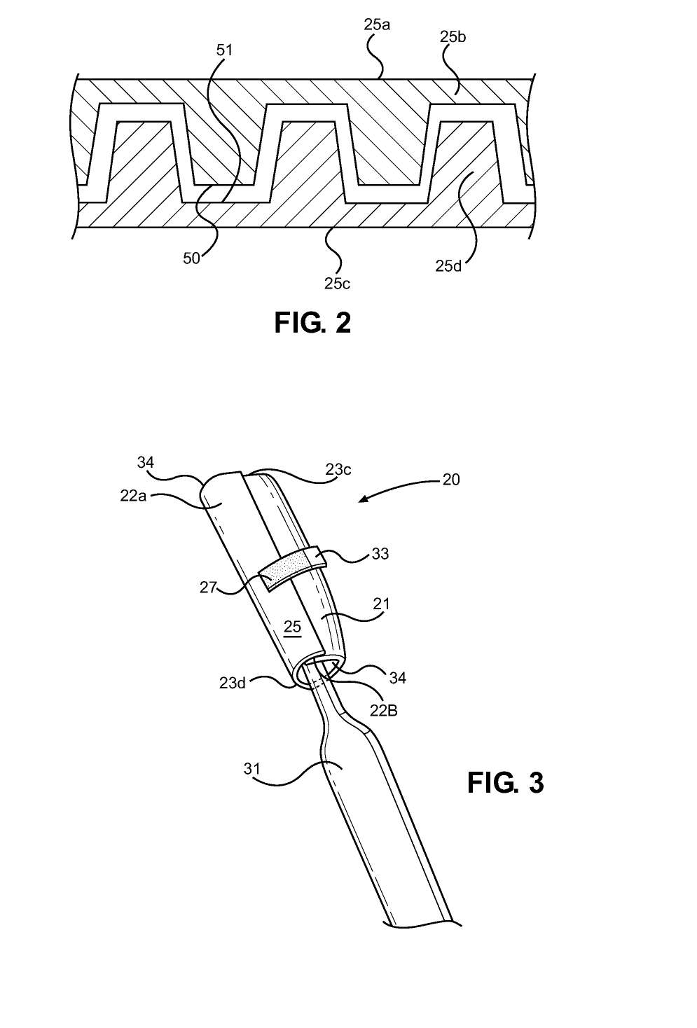

Referring now to FIG. 2, there is shown a sectional view of the upper ply 24A and the lower ply 24B. The upper ply 24A and the lower ply 24B are preferably attached by embossing. In other embodiments, gluing or other suitable means of attachment are used. Preferably embossing is done partially around the perimeter of the upper ply 24A and the lower ply 24B, however, other embodiments include embossing along the entire perimeter or in any other suitable or decorative pattern. The upper ply 24A comprises a coextensive exterior surface 25A and an interior surface 25B, whereas the lower ply 24B comprises a coextensive exterior surface 25C and an interior surface 25D. The interior surface 25B pf the upper ply 24A comprises raised portions 50 that extend downwardly, while the interior surface 25D of the lower ply 24B includes recessed portions 51, wherein the raised portions 50 engage and nest into the recessed portions for attachment. In this manner, the upper ply 24A and the lower ply 24B create trapped air pockets to increase bulk and absorbent capacity. In another preferred embodiment, glue is applied only to the raised portions of the plies 24 for attachment.

Referring now to FIG. 3, there is shown an overhead perspective of the towel 20 as removably wrapped around the toothbrush 31. The fabric 21 is is designed to be wrapped around the head of a toothbrush wherein the front edge 22A of the fabric 21 is wrapped over and above the rear edge 22B. Based on the placement, size, and shape of toothbrush 31 thereon before wrapping, towel 20 can also be wrapped therearound in a cylindrical fashion with more than one revolution.

The front edge 22A further comprises a reusable tape 27 substantially in the middle of the length of front edge 22A. As the upper ply 24A is removably wrapped around the head of toothbrush 31 and the front edge 22A is folded over the rear edge 22B, the reusable tape 27 is designed to removably secure front edge 22A to the rear edge 22B and removably secure towel 20 around the head of the toothbrush 31. Tape 27, in the preferred embodiment, is office tape, however, without limitation, other suitable pressure sensitive tapes are used in other embodiments.

Tape 27 has a transparent film backing and an acrylic based adhesive, however other embodiments may also use a synthetic rubber based adhesive. Tape 27 further comprises a top portion 33 that does not comprise an adhesive to provide a region for a user to hold to removably secure tape 27 to the rear edge 22B. Tape 27 is single-coated, however, in some embodiments, tape 27 is double-coated tape.

The toothbrush 31 with towel 20 thereon can then be placed in a cup or a toothbrush holder in an upright position. The upper side 23C and lower side 23D do not encase the head of the toothbrush 31 when wrapped thereound in a cylindrical fashion to form a pair of openings 34. The openings 34 are designed to allow air to circulate therethrough to prevent a moist environment that promotes bacteria growth.

Referring now to FIG. 5, towel 20 may further include a box 35 to store a plurality of towels 20 therein. In the illustrated embodiment, the box 35 is in a rectangular prism shape, however, other embodiment, may include other shapes and forms. The box 35 further comprises a slit 36 across the top side 37. Slit 36 is substantially in the center of top side 37 and is designed to allow a user to pull a towel 20 from therein. A plurality of towels 20 are stacked into two separate columns before being stored therein. Each towel 20 in one column is alternatively layered on a towel in the other column which allows one towel 20 to pull therethrough slit 36. The box 35 is preferably composed of cardboard, however other embodiments of the box 35 may be composed of other suitable types of storage.

In some embodiments, box 35 may also comprise a plurality of reusable tape 27 substantially attached to a side surface 38. However, other embodiments may attach the tape 27 on a different surface of box 35. A plurality of tape 27 are juxtaposed on one another in a stack and removably adhered to one another. The top portion 33 of each piece of tape 27 is designed to allow one tape 27 to be removed from the stack of tape 27. In other embodiments, a plurality of towels 20 may be attached to one another by connecting edges and wrapped around a hollow cylindrical core.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above descriptions then, it is to be realized that the optimum dimensional relationships for the parts of the invention, to include variations in size, materials, shape, form, function, and manner of operation, assembly and use, are deemed readily apparent and obvious to one skilled in the art, and all equivalent relationships to those illustrated in the drawings and described in the specifications are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. A toothbrush dryer towel, comprising;
a fabric having a rectangular shape and a front edge, a rear edge, an upper side, a lower side, an upper ply, and a coextensive lower ply;
said upper ply and said lower ply each having exterior surfaces and interior surfaces;
a tape substantially attached to the middle of said front edge.

2. The toothbrush dryer towel of claim 1, wherein said interior surface of said lower ply placed in contact and above said interior surface of said upper ply.

3. The toothbrush dryer towel of claim 2, wherein said upper and lower plies are embossed to attach said upper ply and said lower ply together.

4. The toothbrush dryer towel of claim 3, wherein said interior surface of said upper ply further comprising recessed portions and said interior surface of said lower ply further comprising comprises raised portions.

5. The toothbrush dryer towel of claim 4, wherein said recessed portions engage and nest into said recessed portions to attach said upper ply and said lower ply together.

6. The toothbrush dryer towel of claim 1, wherein said tape comprises a transparent film backing and an acrylic based adhesive, and a top portion without adhesive.

7. The toothbrush dryer towel of claim 1, wherein said tape is rectangular in shape.

8. The toothbrush dryer towel of claim 1, wherein said fabric wrapped around a toothbrush in a tubular and cylindrical fashion leaving a pair of openings formed by said upper side and said lower side.

9. The toothbrush dryer towel of claim 1, wherein said tape attached to said front edge is designed to removably secure to said rear edge to secure said fabric around a toothbrush.

10. The toothbrush dryer towel of claim 1, further comprising a box having at least one side.

11. The toothbrush dryer towel of claim 10, wherein said box further comprising a plurality of said tape removably attached to a surface of said box.

12. The toothbrush dryer towel of claim 11, wherein said tape are juxtaposed on one another and removably adhered to one another to form a stack.

13. The toothbrush dryer towel of claim 1, wherein said lower side further comprising a rectangular portion attached substantially to the middle of said lower side and extending downwardly on the same singular plane.

14. The toothbrush dryer towel of claim 13, wherein said rectangular portion further comprises said upper ply and said lower ply.
